(19) United States
(12) Patent Application Publication
(10) Pub. No.: US 2006/0047911 A1
(43) Pub. Date: Mar. 2, 2006

(54) Method and apparatus for enabling early memory reads for node local data

(75) Inventors: Greg R. Mewhinney, Austin, TX (US); Mysore Sathyanarayana Srinivas, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/932,723

(22) Filed: Sep. 2, 2004

(51) Int. Cl. G06F 12/00

(52) U.S. Cl. 711/119; 711/124; 711/146

(57) ABSTRACT

A method, apparatus, and computer instructions for accessing data. In response to identifying a transaction requiring data, address information is obtained for the data. The address information includes an indication of whether the data is unlikely to be located on remote caches for local nodes. The remote caches for local nodes are searched if the indication is present in the address information. The data is requested from main memory if the indication is absent.

### BACKGROUND OF THE INVENTION

1. Technical Field

The present invention relates generally to an improved data processing system and in particular to a method and apparatus for processing data. Still more particularly, the present invention relates to a method, apparatus, and computer instructions for accessing data in a data processing system.

2. Description of Related Art

In scaling the performance of large symmetric multiprocessor (SMP) data processing systems, memory latency is one of the most challenging limitations on increasing performance. Each processor, has its own memory cache, which is also referred to as a local memory. Current memory implementations lack the knowledge of how a specific portion of memory will be used. As a result, all memory accesses are treated the same or uniformly. As used herein, a node may be made up of one or more processors. In particular, a node may be composed of one or more processors that share a highest level of a local cache. Large symmetric multiprocessor data processing systems are often divided into multiple nodes in which each node manages its own memory cache. Additionally, each node maintains coherency of data in its memory cache by communicating changes in the cache state to other nodes. These other nodes are referred to as remote nodes with respect to the node in which the memory change has occurred. When a processor needs data, this processor checks its own cache first. At some point in time, if the needed data is not found in the local memory cache, the processor will query other nodes to see if the data is contained in their respective memory caches. If the data cannot be found in the local or remote memory caches, the data is then obtained from the main memory.

Depending on a variety of factors, accesses to the main memory may be started as early as a miss at the node's highest level of cache memory. This type of access also is referred to as a speculative access. The access to main memory also may begin as late as when all of the remote nodes have confirmed that the data does not exist in their memory caches. Such an access is referred to as a non-speculative access. The different factors that may affect the access include the size of the data processing system and the memory bus bandwidth. Selecting the appropriate memory access strategy typically is set for the particular machine. More specifically, a particular type of memory access strategy, such as speculative or non-speculative, is set up at the start up of a system and cannot be changed during the operation of the system in currently available data processing systems. Having a set strategy may result in slower accesses in some cases than others. As a result, achieving good scaling performance becomes more difficult as the number of nodes increases.

Therefore, it would be advantageous to have an improved method, apparatus, and computer instructions for increasing the performance in reading data from memory in a data processing system containing multiple nodes.

### SUMMARY OF THE INVENTION

The present invention provides a method, apparatus, and computer instructions for accessing data. Hints as to whether data is unlikely to be found in caches belonging to remote nodes is provided. If this type of hint is provided, a speculative read is launched from the main memory as soon as it is known that the data does not reside in the cache for the local node. If the hint is absent, the process waits until remote nodes have indicated that their caches do not contain the requested data before starting a read from the main memory.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system that may be implemented as a server in accordance with a preferred embodiment of the present invention;

FIG. 3 is a diagram illustrating components used in providing early memory reads for node local data in accordance with a preferred embodiment of the present invention;

FIG. 4 is a diagram illustrating a memory access in accordance with a preferred embodiment of the present invention; and

FIG. 5 is a flowchart of a process for setting indicators in accordance with a preferred embodiment of the present invention.

### DETAILED DESCRIPTION OF THE PREFERRED EMBODIMENT

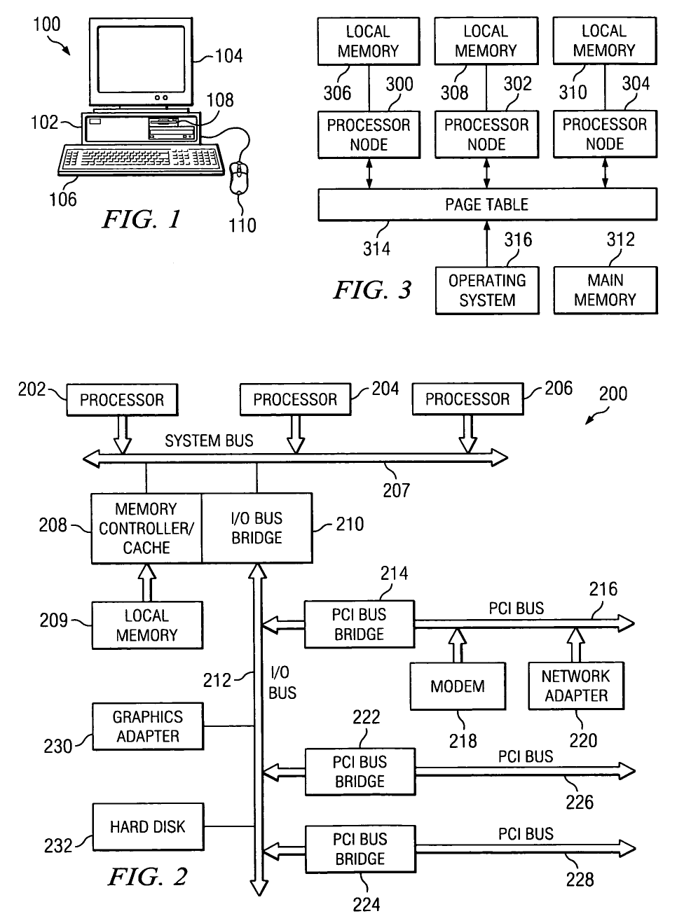

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eserver computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202, 204, and 206 connected to system bus 207. Also connected to system bus 207 is memory controller/cache 208, which provides an interface to local memory 209. I/O bus bridge 210 is connected to system bus 207 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to other data processing systems may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

The present invention provides an improved method, apparatus, and computer instructions for enabling early memory reads for node local data. In these examples, node local data is a class or type of data that is unlikely to be found in the caches of remote nodes. In particular, the mechanism of the present invention allows for nodes, such as processors or processor cores, to access data more quickly.

When an operating system allocates data for a process, the operating system supplies information to the allocator about the memory region's intended use in these examples. An allocator in these examples is a kernel service that fulfills requests for specific amounts of memory with specific mappings needed by a process. If the pages of a region of memory are intended to be used as process private memory, an indicator or flag may be set in the page table entry for the page to indicate that the page will benefit from early memory access. Process private memory is a memory that can only be accessed by an owning process. This type of data is commonly known as data, bss, stack, and heap. This type of use of the region of memory may be, for example, a heap, stack, or data. Later, when a processor requests the data to be loaded, address translation is performed by the processor, which is also referred to as a node in these examples. The indicator or early flag status is associated with the load request that initiated the access for the data. If the request misses the highest level of the node local cache, a decision is made based on the flag. Currently available data processing systems have a cache hierarchy. When a request for data arrives, the different levels of the cache hierarchy are checked in the order of their position in the hierarchy. The highest level is the last level of cache to be checked. The highest level of the cache is that which, if checked, and if the data is not found, confirms that the data does not exist on the local node and must be sourced from a remote node or main memory. In these examples, the node local cache is the cache that does not require a bus operation for access. Remote caches and main memory require a bus operation for a node to access these memory devices. If the early flag or indicator is set, a read from the main memory is initiated without delay.

To make the assumption that the private memory will not reside in remote caches, the operating system in these examples provides facilities to enforce processor and/or node affinity. Most operating systems are multitasking in that processes are dispatched to a processor for a period of time and then removed to allow another process to run for a period of time, before being dispatched again. In this manner, limited processor resources are divided among existing processes. If a data processing system is a symmetric multiprocessing data processing system, a process may be taken off one processor and dispatched on a different processor. Processor affinity is the idea that if a process runs on a processor for a reasonable period of time, the data that it most commonly accesses will continue to reside in the local cache. If the process can be dispatched to the same processor that the process last ran on, the process is likely to find some of the data from its last dispatch remaining in the cache. This type of dispatching saves time needed to reload data from the main memory. A process performs best if it runs on the same processor or node, thus developing an affinity for that particular processor.

Just as in a speculative access, normal coherency protocols are observed, because, although the chance of the data residing in a remote node's cache is small, its absence cannot be guaranteed. Under normal circumstances, the response from the coherency mechanism comes back well before the data is actually available from the main memory. Cache coherency is the synchronization of data in multiple caches, such that reading a memory location via any cache will return the most recent data written to that location via any other cache. Thus, if the data resides on a remote memory cache for another node, the main memory access may be discarded and the cache data used. As a result, coherency is maintained. In this manner, time is saved by launching the access to the main memory early in the process using this mechanism.

Turning now to FIG. 3, a diagram illustrating components used in providing early memory reads for node local data is depicted in accordance with a preferred embodiment of the present invention. These components may be located in a data processing system, such as data processing system 200 in FIG. 2. In this example, three processor nodes, processor node 300, processor node 302, and processor node 304, are present. These processor nodes are associated with local memories 306, 308, and 310 respectively. Processor node 300 uses local memory 306 as its local memory cache. Processor node 302 uses local memory 308 as its local memory cache. In a similar manner, processor node 304 uses local memory 310 as its local memory cache in these illustrative examples. Data is located in main memory 312. The physical address for this data in main memory 312 may be found through page table 314.

In reading or accessing data, processor nodes 300, 302, and 304 access page table 314 to obtain locations for data that they wish to access. Page table 314 contains virtual to physical memory address translations such that a virtual address may be used to obtain an actual physical address. In addition, in accordance with a preferred embodiment of the present invention, entries within page table 314 also include an indicator of whether the data may be found on a remote cache for one of the processor nodes, rather than in main memory 312.

When a processor node, such as processor node 300, requests data, the processor node accesses page table 314 to obtain a physical address of the data in main memory 312. In addition, in these illustrative examples, the entry also contains an indicator or flag that tells processor node 300 whether the data might be located in another local memory for a remote node in the node local cache.

Processor node 300 first searches local memory 306 to see whether the data is present. If the data is not present there, processor node 300 looks at the indicator to see whether the indicator indicates that the data might be located in a local memory for another node. If such an indication is provided, processor node 300 searches the caches associated with the other local nodes first. If the data is not found, then the address for the data is placed onto the bus to obtain the data from main memory 312.

On the other hand, if the indicator indicates that the data is not present in these other caches for the local nodes, then the address is sent to the bus to obtain the data from main memory 312 immediately. Additionally, in these illustrative examples, the nodes also are searched at the same time. The flags or indicators in page table 314 are set in these examples by operating system 316 when operating system 316 allocates data for a process.

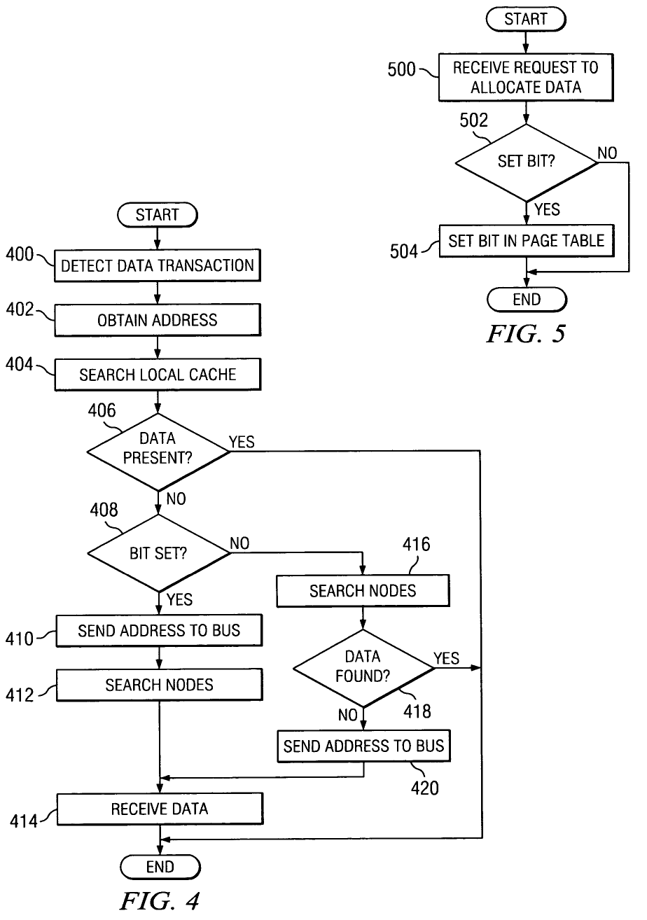

Turning now to FIG. 4, a diagram illustrating a memory access is depicted in accordance with a preferred embodiment of the present invention. The process illustrated in FIG. 4 may be implemented in a processor node, such as processor node 300 in FIG. 3. These processes may be implemented in microcode or through hardware circuitry depending on the particular implementation.

The process begins by detecting a data transaction (step 400). This data transaction is one that requires data to be retrieved for a processor node. Thereafter, the address for the data is obtained (step 402). This address may be obtained for a page table, such as page table 314 in FIG. 3. The local cache for the processor node is first searched (step 404).

Next, a determination is made as to whether the data is present in the local cache for the processor node (step 406). If data is not present, a determination is made as to whether a bit is set for the data (step 408). This bit or indicator is obtained at the same time that the address is obtained in these illustrative examples. The bit or indicator is located as part of an entry for the address translation for the data in a page table.

If the bit is set, this set bit indicates that the data is not likely to be located in a memory cache for one of the other processor nodes. The address for the data is sent to the bus to retrieve the data from main memory (step 410). A search of the memory caches of the other nodes is made (step 412). In these examples, the search of the remote nodes is made to maintain memory coherency. The operating system may create conditions such as strict affinity, that make it unlikely that the designated data will be found in remote caches. As a result, a guarantee cannot be made that the data will not be found in the remote caches. Of course in another illustrative embodiment, a guarantee may be made in a hint to indicate that the data will not be found on a remote cache. Steps 410 and 412 may be made simultaneously depending on the particular implementation. Thereafter, data is received (step 414) with the process terminating thereafter.

With reference again to step 408, if the bit is not set, this unset bit indicates that the data requested by the node may be located in one of the memory caches of the other nodes. The other nodes are then searched (step 416). A determination is made as to whether data is found in this search (step 418). If data is not found, then the address for the data is sent to the bus to retrieve the data from the main memory (step 420) with the process then proceeding to step 414 as described above.

With reference again to step 418, if the data is found, the process terminates. This type of search provides for a non-speculative node in which access to the main memory for the data is made only when the data is not returned from the remote nodes because a non-speculative access waits for the search of the remote nodes to complete before accessing the main memory. When the bit is set, a fully speculative read is made in which the access to the main memory and the other nodes is made at the same time or close to the same time.

With reference again to step 406, if data is present, the process terminates. In this situation, the data is found in the local node for the node making the request for data.

Turning now to FIG. 5, a flowchart of a process for setting indicators is depicted in accordance with a preferred embodiment of the present invention. The process illustrated in FIG. 5 may be implemented in an operating system, such as operating system 316 in FIG. 3, in these illustrative examples.

The process begins by receiving a request to allocate data for a process (step 500). Next, a determination is made as to whether the bit should be set in the page table (step 502). If the bit is to be set, the bit is then set in the page table (step 504) with the process terminating thereafter. If the bit is not to be set, the process terminates. In currently available operating systems, a kernel service known as a loader is used to start a process. This loader has all of the knowledge needed to set up the address space for the processes. Additionally, since the loader knows which data is node local, the mechanism of the present invention enables this service to set the page table bit.

Thus, the present invention provides an improved method, apparatus, and computer instructions for enabling more efficient accessing of data in memory. The mechanism of the present invention determines whether to make a speculative type access depending on an indicator associated with the data. In these examples, this indicator is located in a page table associated with address translations for the data. Of course, this indicator may be located in other data structures and may be associated with the data. Also, more than one bit may be used in association with the data to provide additional hints in addition to whether a speculative access should be made. In some computer architectures, the main memory is partitioned in a manner such that some subset of the main memory may be accessed faster than others. The faster portion is located closer to a node than those portions located farther away from the node. An additional bit may provide a hint that the data is unlikely to be found in a far away memory that has slower access. Another type of hint allows the mechanism of the present invention to not bother caching an object that will not be used again in the near future. With more hints, other actions such as for example, a partial speculative access may be made.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMS, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. For example, although the nodes illustrated are on the same data processing system, the mechanism of the present invention may be applied to nodes located on other remote data processing systems. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for accessing data, the method comprising:
responsive to identifying a transaction requiring data, obtaining address information for the data, wherein the address information includes an indication of whether the data is unlikely to be located on remote caches for local nodes;
searching the remote caches for local nodes if the indication indicates that the data is likely to located on remote caches for local nodes; and
requesting the data from main memory if the indication indicates that the data is unlikely to located on remote caches for local nodes.

2. The method of claim 1 further comprising:
requesting data from the main memory if the indication that the data is likely to located on remote caches for local nodes.

3. The method of claim 1, wherein the data is requested from the main memory by placing a memory address for the data on a bus in the data processing system.

4. The method of claim 1, wherein the obtaining step includes:
obtaining the address information for the data from a page table.

5. The method of claim 1, wherein the obtaining step includes:
translating a virtual address for the data into a physical address for the data.

6. The method of claim 1, wherein the transaction is identified by receiving a request from a processor to load the data.

7. The method of claim 1, wherein the data processing system is a symmetric multiprocessor data processing system.

8. A data processing system for accessing data, the data processing system comprising:
obtaining means for, responsive to identifying a transaction requiring data, obtaining address information for the data, wherein the address information includes an indication of whether the data is unlikely to be located on remote caches for local nodes;
searching means for searching the remote caches for local nodes if the indication indicates that the data is likely to located on remote caches for local nodes; and
requesting means for requesting the data from main memory if the indication indicates that the data is unlikely to located on remote caches for local nodes.

9. The data processing system of claim 1 wherein the requesting means is a first requesting means further comprising:
second requesting means for requesting data from the main memory if the indication indicates that the data is likely to located on remote caches for local nodes.

10. The data processing system of claim 1, wherein the data is requested from the main memory by placing a memory address for the data on a bus in the data processing system.

11. The data processing system of claim 1, wherein obtaining means includes:
means for obtaining the address information for the data from a page table.

12. The data processing system of claim 1, wherein the obtaining means includes:
translating means for translating a virtual address for the data into a physical address for the data.

13. The data processing system of claim 1, wherein the transaction is identified by receiving a request from a processor to load the data.

14. The data processing system of claim 1, wherein the data processing system is a symmetric multiprocessor data processing system.

15. A computer program product in a computer readable medium for accessing data, the computer program product comprising:
first instructions for, responsive to identifying a transaction requiring data, obtaining address information for the data, wherein the address information includes an indication of whether the data is unlikely to be located on remote caches for local nodes;
second instructions for searching the remote caches for local nodes if the indication indicates that the data is likely to located on remote caches for local nodes; and
third instructions for requesting the data from main memory if the indication indicates that the data is unlikely to located on remote caches for local nodes.

16. The computer program product of claim 1 further comprising:
fourth instructions for requesting data from the main memory if the indication indicates that the data is likely to located on remote caches for local nodes.

17. The computer program product of claim 1, wherein the data is requested from the main memory by placing a memory address for the data on a bus in the data processing system.

18. The computer program product of claim 1, wherein the first instructions includes:
sub instructions for obtaining the address information for the data from a page table.

19. The computer program product of claim 1, wherein the first instructions includes:
sub instructions for translating a virtual address for the data into a physical address for the data.

20. The computer program product of claim 1, wherein the transaction is identified by receiving a request from a processor to load the data.

21. The computer program product of claim 1, wherein the data processing system is a symmetric multiprocessor data processing system.

22. A data processing system for accessing data, the data processing system comprising:
a bus system;
a communications unit connected to the bus system;
a memory connected to the bus system, wherein the memory includes a set of instructions; and
a processing unit connected to the bus system, wherein the processing unit executes the set of instructions, responsive to identifying a transaction requiring data, to obtain address information for the data, wherein the address information includes an indication of whether the data is unlikely to be located on remote caches for local nodes; search the remote caches for local nodes if the indication indicates that the data is likely to located on remote caches for local nodes; and request the data from main memory if the indication indicates that the data is unlikely to located on remote caches for local nodes.
